(19) United States
(12) Patent Application Publication
(10) Pub. No.: US 2026/0302114 A1
(43) Pub. Date: Oct. 1, 2026

(54) CONTACTOR

(71) Applicant: Schneider Electric Industries SAS, Rueil-Malmaison (FR)

(72) Inventors: Yuanzhong WANG, Shanghai (CN); Zhiping HUAN, Shanghai (CN); Yang ZHOU, Shanghai (CN); Zhen LI, Shanghai (CN); Tongyu LIU, Xi'an (CN); Kailiang FU, Xi'an (CN); Xu HAN, Shanghai (CN)

(21) Appl. No.: 19/630,758

(22) Filed: Mar. 27, 2026

(30) Foreign Application Priority Data
Apr. 1, 2025 (CN) 2025206050493

(51) Int. Cl. H01H 50/16; H01H 50/02; H01H 50/30; H01H 51/06

(52) U.S. Cl. CPC H01H 50/163; H01H 50/02; H01H 50/30; H01H 51/06

(57) ABSTRACT

Embodiments of the disclosure provides a contactor including a housing assembly and a buffer member. The housing assembly includes a first housing and a second housing which are installed together. The first housing is provided with a receiving cavity, a fixed core is installed in the receiving cavity, and a first limiting surface is formed on the fixed core. A fixed contact is installed on the second housing. The second housing includes a second limiting surface opposite to the first limiting surface, and the second limiting surface is provided with a groove. The buffer member is disposed in the groove and abuts against the first limiting surface.

### CROSS-REFERENCE

This application claims priority to Chinese Patent Application No. 202520605049.3, filed on Apr. 01, 2025, and entitled “CONTACTOR”, the entirety of which is incorporated herein by reference.

### FIELD

Embodiments of the present disclosure generally relate to the field of electrical equipment, and more particularly to a contactor.

### BACKGROUND

A contactor mainly includes an electromagnetic system, a contact system, and an arc extinguishing system. The electromagnetic system includes a coil, a fixed core, and a movable core. The contact system includes a fixed contact and a movable contact. The coil, the fixed core and the fixed contact are fixed on a housing of the contactor. The movable core and the movable contact are disposed on a movable contact support, and the movable contact support is slidably fitted with the housing of the contactor. The movable contact support may be movable between an initial position and an operating position, so that the movable contact abuts against or is separated from the fixed contact. A return spring is disposed in the housing of the contactor, and the return spring keeps the movable contact support in the initial position by exerting a force on the movable core. When the coil is energized, an electromagnetic attraction force generated by the fixed core attracts the movable core to move, thereby switching the movable contact support from the initial position to the operating position. The arc extinguishing system is used to extinguish an arc generated when the movable contact is separated from the fixed contact.

### SUMMARY

The present disclosure provides a contactor including a housing assembly and a buffer member. The housing assembly includes a first housing and a second housing which are installed together. The first housing is provided with a receiving cavity, a fixed core is installed in the receiving cavity, and a first limiting surface is formed on the fixed core. A fixed contact is installed on the second housing. The second housing includes a second limiting surface opposite to the first limiting surface, and the second limiting surface is provided with a groove. The buffer member is disposed in the groove and abuts against the first limiting surface.

In some embodiments, the groove includes a straight groove portion and a flared portion connected to each other, and the buffer member passes through the flared portion and is fitted with the straight groove portion.

In some embodiments, at least a portion of a side wall of the flared portion is inclined relative to a corresponding side wall of the straight groove portion, and/or at least a portion of the side wall of the flared portion is arc-shaped. An intersection between the at least a portion of the side wall of the flared portion and the corresponding side wall of the straight groove portion is smoothly rounded.

In some embodiments, a cross-sectional shape of the flared portion and a cross-sectional shape of the straight groove portion are each rectangular or circular.

In some embodiments, the buffer member includes a base portion and at least one extension portion extending from a top surface of the base portion, a cross-sectional dimension of the at least one extension decreases in a direction away from the base portion. A top surface of the extension portion abuts against a bottom wall of the groove, and a bottom surface of the base portion abuts against the first limiting surface.

In some embodiments, a side surface of a portion of the base portion abuts against a side wall of the straight groove portion; and/or a side surface of the at least one extension portion is provided with a positioning protrusion, and the at least one extension portion abuts against the side wall of the straight groove portion through the positioning protrusion.

In some embodiments, the buffer member includes at least two extension portions, and every two adjacent extension portions are spaced apart.

In some embodiments, the buffer member includes a base portion and at least one extension portion extending from a top surface of the base portion, a cross-sectional dimension of the at least one extension decreases in a direction away from the base portion. A bottom surface of the base portion abuts against a bottom wall of the groove, and a top surface of the extension portion abuts against the first limiting surface.

In some embodiments, a height of the base portion is smaller than a depth of the groove.

In some embodiments, the bottom surface of the base is provided with at least one positioning hole which extends into the at least one extension portion. The bottom wall of the groove is provided with at least one positioning column, the at least one positioning column is fitted with the at least one positioning hole, and a height of the positioning column is smaller than a depth of the corresponding positioning hole.

It should be understood that the content described in this content section is not intended to limit the key features or important features of embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 shows a schematic cross-sectional view of a contactor according to an embodiment of the present disclosure;

FIG. 2 shows a schematic cross-sectional view of a groove and a buffer member of the contactor shown in FIG. 1, taken along a direction;

FIG. 3 shows a schematic cross-sectional view of a groove, a buffer member, and a fixed core of the contactor shown in FIG. 1, taken along a further direction, where the buffer member is pre-compressed;

FIG. 4 shows an enlarged schematic view of a portion of a second housing of the contactor shown in FIG. 1;

FIGS. 5 and 6 shows schematic structural views of the buffer member of the contactor shown in FIG. 1 when viewed from different perspectives;

FIG. 7 shows a schematic cross-sectional view of a contactor according to a further embodiment of the present disclosure;

FIG. 8 shows an enlarged schematic view of a portion A in FIG. 7;

FIG. 9 shows an enlarged schematic view of a portion of the second housing of the contactor shown in FIG. 7; and

FIG. 10 shows a schematic structural view of a buffer member of the contactor shown in FIG. 7.

### DETAILED DESCRIPTION

Embodiments of the present disclosure will be described in more detail below with reference to the accompanying drawings. While embodiments of the present disclosure are shown in the drawings, it should be understood that the present disclosure may be implemented in various forms and should not be limited by embodiments set forth herein. Rather, these embodiments are provided to make this disclosure more thorough and complete, and to fully convey the scope of the present disclosure to those skilled in the art.

As used herein, the term “including” and variations thereof represent openness, i.e., “including but not limited to”. Unless specifically stated, the term “or” means “and/or”. The terms “an example embodiment” and “an embodiment” mean “at least one example embodiment”. The term “another embodiment” means “at least one further embodiment”. The terms “first”, “second”, and the like may refer to different or identical objects.

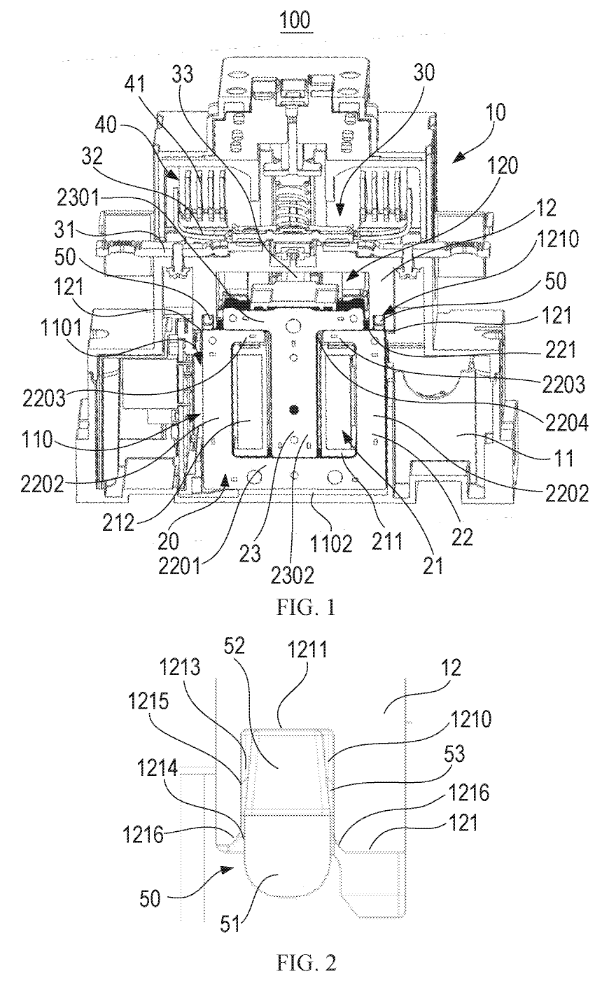

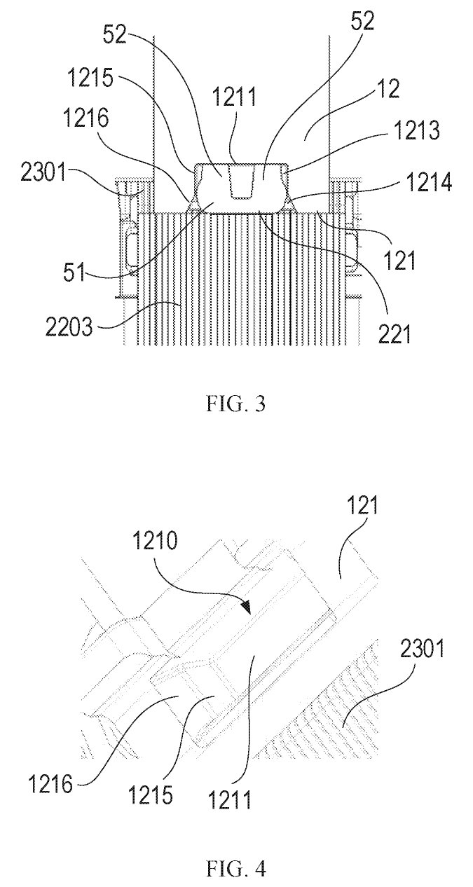

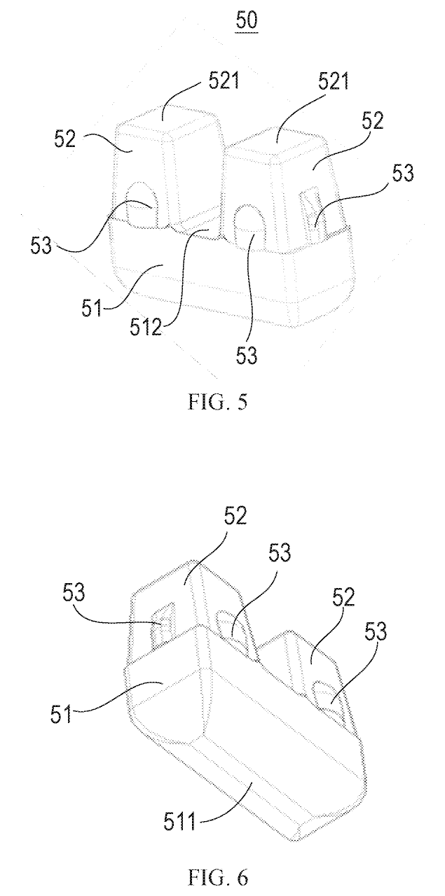

FIG. 1 illustratively shows a cross-sectional view of a contactor 100 according to an embodiment of the present disclosure. The contactor 100 may also be referred to as an electromagnetic contactor. FIG. 2 illustratively shows a schematic cross-sectional view of a groove 1210 and a buffer member 50 shown in FIG. 1, taken along a direction. FIG. 3 illustratively shows a schematic cross-sectional view of the groove 1210, the buffer member 50, and a fixed core 22 shown in FIG. 1, taken along a further direction, where the buffer member 50 is pre-compressed. The sectioning direction of FIG. 3 is perpendicular to that of FIG. 2. FIG. 4 shows an enlarged schematic view of a portion of a second housing 12 shown in FIG. 1. FIGS. 5 and 6 shows schematic structural views of the buffer member 50 shown in FIG. 1 when viewed from different perspectives. The contactor 100 will be described below with reference to FIGS. 1-6.

Referring to FIG. 1, the contactor 100 may include a housing assembly 10, an electromagnetic system 20, a contact system 30, and an arc extinguishing system 40.

The housing assembly 10 is of a split structure and may be assembled from a plurality of housing parts. In some embodiments, the housing assembly 10 includes a first housing 11 and a second housing 12 which are installed together. A coil (also referred to as an electromagnetic coil) 21, and a fixed core (also referred to as a stationary iron core) 22 of the electromagnetic system 20 may be installed on the first housing 11. A movable core (also referred to as a movable iron core) 23 of the electromagnetic system 20, the contact system 30, and the arc extinguishing system 40 may be installed on the second housing 12.

In some alternative embodiments, the first housing 11 and/or the second housing 12 may themselves be of a split structure. For example, the first housing 11 may include a first frame body and a first cover body installed on the first frame body, and the first cover is attached to a side of the first frame body facing away from the second housing 12. The second housing 12 may include a second frame body (also referred to as a middle frame) and a second cover body installed on the second frame body, and the second cover body is attached to a side of the second frame body facing away from the first housing 11. Of course, the structures of the first housing 11 and the second housing 12 may be designed according to actual needs and are not limited to the above examples.

With continued reference to FIG. 1, the first housing 11 is provided with a receiving cavity 110, and the receiving cavity 110 has an opening 1101 opposite to the second housing 12. For example, the coil 21 and the fixed core 22 may pass through the opening 1101 and be fixed in the receiving cavity 110.

The second housing 12 is provided with a receiving cavity 120 opposite to the receiving cavity 110. The receiving cavity 120 is configured to allow at least a portion of the movable core 23 of the electromagnetic system 20 to slide therein. The second housing 12 is further provided with a second limiting surface 121 opposite to the opening 1101. In some embodiments, the second limiting surface 121 may mate with a bottom wall 1102 of the receiving cavity 110 to define a position of the fixed core 22 in a sliding direction of the movable core 23.

As previously mentioned, the electromagnetic system 20 includes the coil 21, the fixed core 22, and the movable core 23. The coil 21 may include a coil holder 211 and a winding 212 wound around the coil holder 211. The fixed core 22 is disposed adjacent to the coil 21. The movable core 23 is connected to the movable contact support 33 of the contact system 30, and the movable contact support 33 is slidably fitted with the second housing 12. When the coil 21 is energized, the fixed core 22 generates an electromagnetic attraction force, so that the movable core 23 is attracted by the fixed core 22 and moves towards the fixed core 22 to be engaged with the fixed core 22. When the coil 21 is de-energized, the electromagnetic attraction force of the fixed core 22 disappears, and the movable core 23 can move in a direction away from the fixed core 22 under the action of a return spring which is not shown.

Referring to FIG. 1, in some embodiments, the fixed core 22 may be formed by laminating silicon steel sheets. The fixed core 22 may include a bottom portion 2201, two extending portions 2202, and two supporting portions 2203. The bottom portion 2201 is supported, for example, by the bottom wall 1102 of the receiving cavity 110. The two extending portions 2202 extend from opposite ends of the bottom portion 2201 towards the opening 1101, respectively. The two supporting portions 2203 extend towards each other from the ends of the two extending portions 2202 away from the bottom portion 2201. A spacing 2204 is formed between the two supporting portions 2203. A first limiting surface 221 is formed on a surface of the two supporting portions 2203 facing towards the second housing 12. The first limiting surface 221 is opposite to the second limiting surface 121 and is configured to mate with the second limiting surface 121, so as to limit movement of the fixed core 22 towards the second housing 12.

The coil 21 is fixed in the space defined by the fixed core 22. A central hole of the coil holder 211 of the coil 21 is aligned with the spacing 2204.

The movable core 23 may be formed by laminating silicon steel sheets. The movable core 23 may be T-shaped, including a supporting portion 2301 and a column portion 2302 extending from a middle portion of the supporting portion 2301. The supporting portion 2301 is slidably relative to the second housing 12 in the receiving cavity 120. The column portion 2302 passes through the spacing 2204 and extends into the central hole of the coil holder 211, and the column portion 2302 is slidably fitted with the central hole of the coil holder 211. When the coil 21 is energized, the supporting portion 2301 of the movable core 23 may be attracted to the supporting portion 2203 of the fixed core 22, and the column portion 2302 is attracted to the bottom portion 2201.

Of course, in some alternative embodiments, the coil 21, the fixed core 22, and the movable core 23 may have other configurations, which are not limited to the above examples.

The contact system 30 includes a fixed contact 31, a movable contact 32, and the movable contact support 33 described above. The fixed contact 31 is fixed on the second housing 12, and the movable contact 32 is installed on the movable contact support 33. As can be seen from the above description, by controlling the energization and de-energization of the coil 21, the movable core 23 can drive the movable contact support 33 to slide relative to the second housing 12, thereby realizing the abutment and separation between a movable contact point of the movable contact 32 and a fixed contact point of the fixed contact 31.

The arc extinguishing system 40 includes, for example, an arc extinguishing chamber disposed on the second housing 12 and arc extinguishing grid plates 41 disposed in the arc extinguishing chamber. When the movable contact point of the movable contact 32 is separated from the fixed contact point of the fixed contact 31, a high-temperature arc is generated between the movable contact 32 and the fixed contact 31, and the high-temperature arc can be quickly extinguished by the arc extinguishing system 40.

Referring to FIG. 1 and with reference to the content described above, when the coil 21 of the electromagnetic system 20 is energized, the movable core 23 and the fixed core 22 are attracted to each other and impact occurs, and such impact will cause vibration and rebound of the fixed core 22. For the contactor 100 in which the second limiting surface 121 is in direct abutment with the first limiting surface 221, the vibration and rebound of the fixed core 22 will directly impact the second housing 12, causing the second housing 12 to drive the fixed contact 31 to bounce synchronously, thereby causing poor contact between the fixed contact 31 and the movable contact 32 that have been in abutment with each other, and even causing arcing. The arcing will cause wear and melting of the fixed contact point of the fixed contact 31 and the movable contact point of the movable contact 32, affecting the service life of the contact assembly 30, and further affecting the electrical life of the contactor 100.

With continued reference to FIG. 1, in order to solve the problem that the vibration and rebound of the fixed core 22 directly impact the second housing 12 when the movable core 23 and the fixed core 22 are engaged to each other, in the contactor 100 provided by embodiments of the present disclosure, the second limiting surface 121 of the second housing 12 is provided with a groove 1210, a buffer member 50 is disposed in the groove 1210, and the buffer member 50 protrudes relative to the second limiting surface 121 to abut against the first limiting surface 221 of the fixed core 22. The number of the grooves 1210 and the buffer members 50 may be set as needed. In this way, when the coil 21 is energized and impact occurs as the movable core 23 and the fixed core 22 are attracted to each other, the vibration and rebound of the fixed core 22 are not directly transmitted to the second housing 12, but is transmitted to the second housing 12 via the buffer member 50. Under the buffering effect of the buffer member 50, the impact on the second housing 12 is reduced, thereby avoiding significant bouncing of the second housing 12 and the fixed contact 31, so that the fixed contact 31 can maintain good contact with the movable contact 32. In addition, under the buffering effect of the buffer member 50, the duration of the vibration and rebound of the fixed core 22 caused by the engagement between the movable core 23 and the fixed core 22 can also be greatly reduced. Therefore, the electrical life of the contactor 100 is improved.

FIGS. 2-6 show illustrative embodiments of the buffer member50 and groove 1210 in the contactor 100 shown in FIG. 1.

Specifically, the groove 1210 includes a straight groove portion 1213 and a flared portion 1214 connected to each other. A cross-sectional shape of the straight groove portion 1213 and a cross-sectional shape of the flared portion 1214 are each rectangular. The straight groove portion 1213 is adjacent to a bottom wall 1211 of the groove 1210, and the flared portion 1214 is adjacent to an opening of the groove 1210. A cross-sectional dimension of the straight grooves portion 1213 is substantially uniform. A cross-sectional dimension of the flared portion 1214 gradually increases in a direction away from the straight groove portion 1213.

The buffer member 50 passes through the flared portion 1214 and is fitted with the straight groove portion 1213. It can be understood that the buffer member 50 protrudes relative to the flared portion 1214 to abut against the first limiting surface 221, so that the buffer member 50 is pre-compressed. When the movable core 23 and the fixed core 22 are attracted to each other, and the buffer member 50 is further compressed under the impact from the fixed core 22, the flared portion 1214 can provide a sufficient deformation space for further compressive deformation of the buffer member 50, thereby facilitating improving the stress state of the buffer member 50 during compression and prolonging the service life of the buffer member 50.

Referring to FIGS. 2 and 3, two opposite side walls 1216 of the flared portion 1214 are arc-shaped, and the other two side walls 1216 of the flared portion 1214 are inclined relative to the corresponding side walls 1215 of the straight groove portion 1213. The flared portion 1214 is substantially funnel-shaped. In this way, a sufficient deformation space can be reserved for the compressive deformation of the buffer member 50, so as to further improve the stress state of the buffer member 50 during compression.

Of course, there are many other ways to implement the flared portion 1214, which are not limited to the above examples, as long as the flared portion 1214 can reserve the deformation space for further compressive deformation of the buffer member 50. For example, in some alternative embodiments, a portion of the side walls 1216 of the flared portion 1214 may be inclined relative to corresponding side walls 1215 of the straight groove portion 1213 (e.g., two opposite side walls 1216 of the flared portion 1214 are respectively inclined relative to the corresponding side walls 1215), and the other side walls 1216 may be respectively coplanar with the corresponding side walls 1215 of the straight groove portion 1213. Alternatively, in some alternative embodiments, each side wall 1216 of the flared portion 1214 is inclined relative to the corresponding side wall 1215 of the straight groove portion 1213. Alternatively, in some alternative embodiments, a portion of the side walls 1216 of the flared portion 1214 is arc-shaped (e.g., two opposite side walls 1216 of the flared portion 1214 are arc-shaped), and the other side walls 1216 may be respectively coplanar with the corresponding side walls 1215 of the straight groove portion 1213. Alternatively, in some alternative embodiments, each side wall 1216 of the flared portion 1214 is arc-shaped.

In some embodiments, intersections between each inclined or arc-shaped side wall 1216 of the flared portion 1214 and the corresponding side wall 1215 of the straight groove portion 1213 are smoothly rounded. In some embodiments, an intersection between the flared portion 1214 and the second limiting surface 121 is smoothly rounded. That is, protruding sharp corners in a region where the side walls of the groove 1210 may be in contact with the buffer member 50 may be avoided as much as possible, so as to prevent the buffer member 50 from being scratched by the protruding sharp corners during the compressive deformation.

Referring to FIGS. 5 and 6, the buffer member50 includes a base portion 51 and two extension portions 52 extending from a top surface 512 of the base portion 51. A cross-sectional shape of the base portion 51 and a cross-sectional shape of each extension portion 52 are, for example, rectangular. A cross-sectional dimension of each extension portion 52 decreases in a direction away from the base portion 51. Two adjacent extension portions 52 are spaced apart by a predetermined distance. A top surface 521 of the extension portion 52 away from the base portion 51 abuts against the bottom wall 1211 of the groove 1210, and a bottom surface 511 of the base portion 51 protrudes relative to the groove 1210 to abut against the first limiting surface 221 of the fixed core 22. In some embodiments, an area of the bottom surface 511 of the base portion 51 is smaller than an area of the top surface 512 of the base portion 51.

Referring back to FIGS. 2 and 3, when the buffer member 50 is compressed under the impact from the fixed core 22, a gap between the side walls 1216 of the flared portion 1214 and a side surface of the base portion 51, a gap between the side walls 1215 of the straight groove portion 1213 and side surfaces of the extension portions 52, and a gap between the adjacent extension portions 52 reserve a deformation space for the compressive deformation of the buffer member 50, which further facilitates improving the stress condition of the buffer member 50 and improving the service life of the buffer member 50.

In addition, the manner in which the bottom surface 511 of the base portion 51 abuts against the first limiting surface 221, as compared with the manner in which the top surface 521 of each extension portion 52 abuts against the first limiting surface 221, is more beneficial to improve the wear resistance of the buffer member 50 and the service life of the buffer member 50, so that the buffer member 50 can provide long-term and stable buffering effect.

In some embodiments, a portion of the base portion 51 extends into the straight groove portion 1213, and a side surface of the portion of the base portion 51 abuts against the side walls of the straight groove portion 1213 to fix the position of the buffer member 50 in the groove 1210, thereby preventing the buffer member 50 from shaking relative to the groove 1210.

Referring to FIGS. 2,5 and 6, in some embodiments, the side surfaces of the extension portions 52 are provided with positioning protrusions 53, and the positioning protrusions 53 may, for example, abut against the side walls 1215 of the straight groove portion 1213 to fix the position of the buffer member 50 in the groove 1210, and improve the mechanical property of the buffer member 50.

It should be noted that, although in embodiments shown in FIGS. 1-6, description is made by taking an example in which the base portion 51 is provided with two extension portions 52, and the cross-sectional shapes of the groove 1210, the base portion 51, and each extension portion 52 are rectangular, in some alternative embodiments, the cross-sectional shapes of the groove 1210, the base portion 51, and each extension portion 52, as well as the number of the extension portions 52 may adopt other configurations. For example, in some embodiments, the number of the extension portions 52 may be one or more than two. In some embodiments, the cross-sectional shapes of the groove 1210, the base portion 51, and the extension portions 52 may be circular or other suitable shapes. In some embodiments where more than two extension portions 52 are provided, the plurality of extension portions 52 may be in a linear arrangement, an annular arrangement, or an array arrangement.

In addition, it should be noted that, although in the above embodiments, description is made by taking an example in which the bottom surface 511 of the base portion 51 abuts against the first limiting surface 221, and the top surface 521 of each extension portion 52 abuts against the bottom wall 1211 of the groove 1210, in practical applications, the bottom surface 511 of the base portion 51 may abut against the bottom wall 1211 of the groove 1210, and the top surfaces 521 of the extension portions 52 may abut against the first limiting surface 221, which is also within the protection scope of the present disclosure.

According to embodiments of the present disclosure, the second limiting surface of the second housing is provided with the groove, and the buffer member is disposed in the groove and abuts against the first limiting surface of the fixed core. In this way, when the movable core and the fixed core are attracted to each other and impact occurs therebetween, the vibration and rebound of the fixed core are transmitted to the second housing via the buffer member. Under the buffering effect of the buffer member, the impact on the second housing is reduced, thereby avoiding significant bouncing of the second housing and the fixed contact, so that the fixed contact can maintain good contact with the movable contact. In addition, under the buffering effect of the buffer member, the duration of the vibration and rebound of the fixed core caused by the engagement between the movable core and the fixed core can also be greatly reduced. Therefore, the electrical life of the contactor is improved.

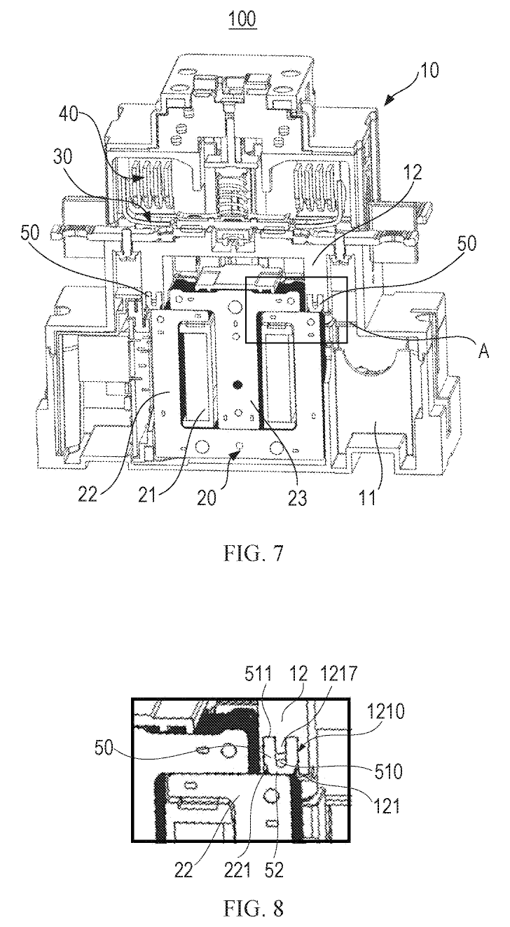

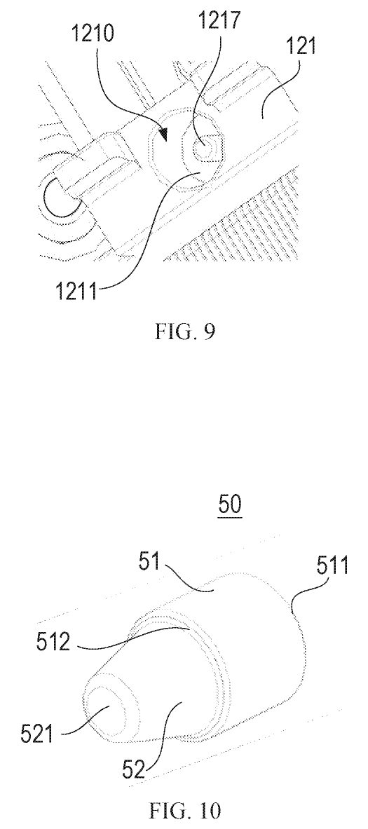

FIG. 7 illustratively shows a schematic cross-sectional view of a contactor 100 according to a further embodiment of the present disclosure. FIG. 8 shows an enlarged view of a portion A in FIG. 7. FIG. 9 illustratively shows an enlarged schematic view of a portion of the second housing 12 in FIG. 7. FIG. 10 illustratively shows a schematic structural view of a buffer member 50 in FIG. 7. The contactor 100 includes a housing assembly 10, an electromagnetic system 20, a contact system 30, an arc extinguishing system 40, and a buffer member50. In the case of no conflict, the structure of the contactor 100 shown in FIG. 7 may be referred to the description of the structure of the contactor 100 shown in FIG. 1, which will not be described herein again.

FIGS. 9 and 10 shows illustrative structures of the buffer member 50 and the groove 1210 in the contactor 100 shown in FIG. 7.

Specifically, the buffer member50 includes a base portion 51 and an extension portion 52 extending from a top surface 512 of the base portion 51. The base portion 51 is fitted with the groove 1210, and a bottom surface 511 of the base portion 51 abuts against a bottom wall 1211 of the groove 1210. The extension portion 52 protrudes relative to the groove 1210, and a top surface 521 of the extension portion 52 away from the base portion 51 abuts against the first limiting surface 221 of the fixed core 22. The cross-sectional shapes of the base portion 51, the extension portion 52, and the groove 1210 are, for example, circular. A cross-sectional dimension of the extension portion 52 decreases in a direction away from the base portion 51.

In some embodiments, a cross-sectional dimension of the groove 1210 is substantially uniform, and a height of the base portion 51 may be smaller than a depth of the groove 1210. When the buffer member 50 is further compressed under an impact from the fixed core 22, a gap between a side surface of the extension portion 52 and a side wall of the groove 1210 provides a deformation space for further compressive deformation of the buffer member 50, which is beneficial to improving the stress state of the buffer member 50 during compression, thereby prolonging the service life of the buffer member 50.

In some alternative embodiments, the groove 120 may include a straight groove portion 1213 and a flared portion 1214 as described above. At this point, a height of the base portion 51 may be smaller than a height of the straight groove portion 1213. That is, a portion of the extension portion 52 extends into the straight groove portion 1213. In this way, the gap between the side surface of the extension portion 52 and the side walls of the straight groove portion 1213 and the flared portion 1214 provides a larger deformation space for the compressive deformation of the buffer member 50, so as to further improve the stress state of the buffer member 50 during compression.

With reference to FIGS. 8 and 9, in some embodiments, the bottom surface 511 of the base portion 51 may be provided with a positioning hole 510, and the positioning hole 510 extends into the extension portion 52. A portion of the positioning hole 510 may be located inside the extension portion 52. The bottom wall 1211 of the groove 1210 is provided with a positioning column 1217. The positioning column 1217 is fitted with the positioning hole 510 to fix the position of the buffer member 50 in the groove 1210. At this point, a deformation space may be reserved between the side surface of the base portion 51 and a side wall of the groove 1210, so as to improve the stress state of the buffer member 50 during compression.

In some embodiments, a height of the positioning column 1217 may be smaller than a depth of a corresponding positioning hole 510. A portion of the positioning hole 510 not fitted with the positioning column 1217 also provides a deformation space for the compressive deformation of the buffer member 50, which further helps to improve the stress state of the buffer member 50 during compression.

It should be noted that, although in embodiments shown in FIGS. 7-10, description is made by taking an example in which cross-sectional shapes of the groove 1210, the base portion 51, and the extension portion 52 are circular, in some alternative embodiments, the groove 1210 and the buffer member 50 may adopt other configurations. For example, in some alternative embodiments, the cross-sectional shapes of the groove 1210, the base portion 51, and the extension portion 52 may be rectangular or other suitable shapes. In some alternative embodiments, the base portion 51 may be provided with two or more extension portions 52. In some embodiments, when more than two extension portions 52 are provided, the plurality of extension portions 52 may be in a linear arrangement, an annular arrangement, or an array arrangement. In some alternative embodiments, when the number of the extension portions 52 is two or more, the bottom surface of the base portion 51 may be provided with two or more positioning holes 510, and each positioning hole 510 extends into the corresponding extension portion 52. Correspondingly, the bottom wall 1211 of the groove 1210 may be provided with positioning posts 1217 corresponding to the positioning holes 510.

According to the contactor 100 provided by embodiments of the present disclosure, the second housing 12 abuts against the fixed core 22 via the buffer member 50, and the vibration and rebound generated when the fixed core 22 is attracted to the movable core 23 is transmitted to the second housing 12 via the buffer member 50. Under the buffering effect of the buffer member 50, the impact on the second housing 12 is reduced, thereby avoiding significant bouncing of the second housing 12 and the fixed contact 31, so that the fixed contact 31 can maintain good contact with the movable contact 32. In addition, under the buffering effect of the buffer member 50, the duration of the vibration and rebound of the fixed core 22 caused by the engagement between the movable core 23 and the fixed core 22 can also be greatly reduced. Therefore, the electrical life of the contactor 100 is improved. In addition, the buffer member 50 can be easily mounted to the second housing 12, and the assembly efficiency of the contactor 100 is less affected. The buffer member 50 has a low cost and has a minor impact on the manufacturing cost of the contactor 100.

Various embodiments of the present disclosure have been described above, which are illustrative, not exhaustive, and are not limited to embodiments disclosed. Many modifications and variations will be apparent to those of ordinary skill in the art without departing from the scope and spirit of the illustrated embodiments. The selection of the terms used herein is intended to explain the principles of the embodiments, practical applications, or technical improvements in the marketplace, or to enable others of ordinary skill in the art to understand the embodiments disclosed herein.

1. A contactor comprising:
a housing assembly comprising a first housing and a second housing which are installed together;
wherein the first housing is provided with a receiving cavity, a fixed core is installed in the receiving cavity, a first limiting surface is formed on the fixed core, a fixed contact is installed on the second housing, the second housing comprises a second limiting surface opposite to the first limiting surface, and the second limiting surface is provided with a groove; and
a buffer member disposed in the groove and abutting against the first limiting surface.

2. The contactor of claim 1, wherein the groove comprises a straight groove portion and a flared portion connected to each other, and the buffer member passes through the flared portion and is fitted with the straight groove portion.

3. The contactor of claim 2, wherein
at least a portion of a side wall of the flared portion is inclined relative to a corresponding side wall of the straight groove portion, and/or at least a portion of the side wall of the flared portion is arc-shaped, and
an intersection between the at least a portion of the side wall of the flared portion and the corresponding side wall of the straight groove portion is smoothly rounded.

4. The contactor of claim 3, wherein a cross-sectional shape of the flared portion and a cross-sectional shape of the straight groove portion are each rectangular or circular.

5. The contactor of claim 2, wherein
the buffer member comprises a base portion and at least one extension portion extending from a top surface of the base portion, a cross-sectional dimension of the at least one extension portion decreases in a direction away from the base portion, and
a top surface of the extension portion abuts against a bottom wall of the groove, and a bottom surface of the base portion abuts against the first limiting surface.

6. The contactor of claim 5, wherein
a side surface of a portion of the base portion abuts against a side wall of the straight groove portion; and/or
a side surface of the at least one extension portion is provided with a positioning protrusion, and the at least one extension portion abuts against the side wall of the straight groove portion through the positioning protrusion.

7. The contactor of claim 5, wherein the buffer member comprises at least two extension portions, and every two adjacent extension portions are spaced apart.

8. The contactor of claim 1, wherein
the buffer member comprises a base portion and at least one extension portion extending from a top surface of the base portion, a cross-sectional dimension of the at least one extension portion decreases in a direction away from the base portion, and
a bottom surface of the base portion abuts against a bottom wall of the groove, and a top surface of the extension portion abuts against the first limiting surface.

9. The contactor of claim 8, wherein a height of the base portion is smaller than a depth of the groove.

10. The contactor of claim 8, wherein
the bottom surface of the base portion is provided with at least one positioning hole which extends into the at least one extension portion; and
the bottom wall of the groove is provided with at least one positioning column, the at least one positioning column is fitted with the at least one positioning hole, and a height of the positioning column is smaller than a depth of the corresponding positioning hole.

11. The contactor of claim 3, wherein
the buffer member comprises a base portion and at least one extension portion extending from a top surface of the base portion, a cross-sectional dimension of the at least one extension portion decreases in a direction away from the base portion, and
a top surface of the extension portion abuts against a bottom wall of the groove, and a bottom surface of the base portion abuts against the first limiting surface.

12. The contactor of claim 11, wherein
a side surface of a portion of the base portion abuts against a side wall of the straight groove portion; and/or
a side surface of the at least one extension portion is provided with a positioning protrusion, and the at least one extension portion abuts against the side wall of the straight groove portion through the positioning protrusion.

13. The contactor of claim 11, wherein the buffer member comprises at least two extension portions, and every two adjacent extension portions are spaced apart.

14. The contactor of claim 4, wherein
the buffer member comprises a base portion and at least one extension portion extending from a top surface of the base portion, a cross-sectional dimension of the at least one extension portion decreases in a direction away from the base portion, and
a top surface of the extension portion abuts against a bottom wall of the groove, and a bottom surface of the base portion abuts against the first limiting surface.

15. The contactor of claim 14, wherein
a side surface of a portion of the base portion abuts against a side wall of the straight groove portion; and/or
a side surface of the at least one extension portion is provided with a positioning protrusion, and the at least one extension portion abuts against the side wall of the straight groove portion through the positioning protrusion.

16. The contactor of claim 14, wherein the buffer member comprises at least two extension portions, and every two adjacent extension portions are spaced apart.

17. The contactor of claim 2, wherein
the buffer member comprises a base portion and at least one extension portion extending from a top surface of the base portion, a cross-sectional dimension of the at least one extension portion decreases in a direction away from the base portion, and
a bottom surface of the base portion abuts against a bottom wall of the groove, and a top surface of the extension portion abuts against the first limiting surface.

18. The contactor of claim 17, wherein a height of the base portion is smaller than a depth of the groove.

19. The contactor of claim 17, wherein
the bottom surface of the base portion is provided with at least one positioning hole which extends into the at least one extension portion; and
the bottom wall of the groove is provided with at least one positioning column, the at least one positioning column is fitted with the at least one positioning hole, and a height of the positioning column is smaller than a depth of the corresponding positioning hole.

20. The contactor of claim 3, wherein
the buffer member comprises a base portion and at least one extension portion extending from a top surface of the base portion, a cross-sectional dimension of the at least one extension portion decreases in a direction away from the base portion, and
a bottom surface of the base portion abuts against a bottom wall of the groove, and a top surface of the extension portion abuts against the first limiting surface.
